(19) United States
(12) Patent Application Publication
(10) Pub. No.: US 2018/0226022 A1
(43) Pub. Date: Aug. 9, 2018

(54) PIXEL DRIVING CIRCUIT AND ORGANIC LIGHT-EMITTING DISPLAY DEVICE

(71) Applicant: Shenzhen China Star Optoelectronics Technology Co., Ltd., Shenzhen, Guangdong (CN)

(72) Inventor: Xiaoling WU, Shenzhen, Guangdong (CN)

(73) Assignee: Shenzhen China Star Optoelectronics Technology Co., Ltd., Shenzhen, Guangdong (CN)

(21) Appl. No.: 15/504,334

(22) PCT Filed: Jan. 18, 2017
(86) PCT No.: PCT/CN2017/071593

§ 371 Date: Feb. 16, 2017

(30) Foreign Application Priority Data
Dec. 28, 2016 (CN) 201611237361.3

(51) Int. Cl. G09G 3/3233; G09G 3/3258; G09G 3/3266; G09G 3/3291

(52) U.S. Cl. CPC G09G 3/3233; G09G 3/3291; G09G 3/3266; G09G 3/3258

(57) ABSTRACT

The disclosure provides a pixel driving circuit, including an organic light-emitting diode, a driving transistor driving the organic light-emitting diode, a first transistor controlled by a first scanning signal, a second transistor controlled by a second scanning signal, a first capacitor connected between a first node and a maintaining node, a second capacitor connected between the first node and a second node, a third capacitor connected between the maintaining node and the second node. The driving transistor includes a first node that forms a gate node, a second node connected to the organic light-emitting diode and a third node connected to a driving voltage line. The first transistor is connected between a reset voltage line and the first node. The second transistor is connected between the maintaining node and a data line. The current of an organic light-emitting diode and a threshold voltage of a driving transistor are unrelated.

### TECHNICAL FIELD

The disclosure relates to an organic light-emitting technical field, and more particularly to a pixel driving circuit and an organic light-emitting display device.

### DESCRIPTION OF RELATED ART

In recent years, an organic light-emitting diode (OLED) display has been a popular nascent flat panel display product around the world because the OLED display is self-luminous, widely viewed (above 175°), quickly responded (1 μs) with high light-emitting efficiency, wide color gamut and a low working voltage, as well as a thin thickness (below 1 mm), capable of producing a large-sized flexible display and being made with a simple process, further including potential of low costs.

Conventional OLED displays can be classified into a PMOLED and an AMOLED according to driving manners. In the AMOLED, a thin film transistor (TFT) and capacitor storing signals can control brightness and grayscale of the OLED. In order to achieve an objective of driving certain current, each pixel needs to be formed by at least two TFTs and a storing capacitor, which is a 2T1C mode. FIG. 1 is a circuit diagram of a basic driving circuit of a conventional AMOLED. Referring to FIG. 1, the basic driving circuit of the conventional AMOLED includes two TFTs and a capacitor, specifically, a switch TFT T1, a driving TFT T2 and a storing capacitor Cst are included. The driving current of the OLED is controlled by the driving TFT T2, the current is I_{OLED}=k(V_{gs}−Vₜₕ)², k is an Eigen conductive factor of the driving TFT T2, which is determined by characteristics of the driving TFT T2, Vth is a threshold voltage of the driving TFT T2. The threshold voltage Vth of the driving TFT T2 will drift due to long time of manipulation, further leading to variation of the OLED driving current, the OLED display can be interrupted and the image will be poor in performance.

### SUMMARY

An objective of the disclosure is to provide a pixel driving circuit and an organic light-emitting display device that can eliminate influence of a threshold voltage of a driving transistor.

According to one aspect of the disclosure, the pixel driving circuit is provided, which includes an organic light-emitting diode, a driving transistor driving the organic light-emitting diode, a first transistor controlled by a first scanning signal, a second transistor controlled by a second scanning signal, a first capacitor connected between the first node and a maintaining node, a second capacitor connected between the first node and the second node, a third capacitor connected between the maintaining node and the second node. The driving transistor includes a first node that forms a gate node, a second node connected to the organic light-emitting diode and a third node connected to a driving voltage line. The first transistor is connected between a reset voltage line and the first node. The second transistor is connected between a maintaining node and a data line.

In an embodiment of the disclosure, capacitance of the third capacitor is less than capacitance of the first capacitor or capacitance of the second capacitor.

In an embodiment of the disclosure, the driving voltage line provides a low level driving voltage or a high level driving voltage, the reset voltage line provides a low level reset voltage, the data line provides a low level data voltage that is identical to the low level reset voltage or a high level data voltage. The pixel driving circuit operates reset manipulation, collecting a threshold voltage manipulation, data input manipulation and light-emitting manipulation.

In an embodiment of the disclosure, when the pixel driving circuit operates the reset manipulation, the first transistor and the second transistor are turned on, the driving voltage line provides the low level driving voltage, the reset voltage line provides the low level reset voltage, the date line provides the low level data voltage.

In an embodiment of the disclosure, when the pixel driving circuit operates the collecting a threshold voltage manipulation, the first transistor is turned on, the second transistor is turned off, the driving voltage line provides the high level driving voltage. The reset voltage line provides the low level reset voltage.

In an embodiment of the disclosure, when the pixel driving circuit operates the data input manipulation, the first transistor is turned off, the second transistor is turned on, the driving voltage line provides the high level driving voltage, the data line provides the high level data voltage.

In an embodiment of the disclosure, when the pixel driving circuit operates the light-emitting manipulation, the first transistor and the second transistor are turned off, the driving voltage line provides the high level driving voltage.

According to another aspect of the disclosure, an organic light-emitting display device is further provided, which includes a display panel disposed with data lines and scanning lines limiting a plurality of pixels, a data driver driving the data lines, a scanning driver driving the scanning lines, a sequence controller controlling the data driver and the scanning driver. The pixel includes an organic light-emitting diode, a driving transistor driving the organic light-emitting diode, a first transistor controlled by a first scanning signal, a second transistor controlled by a second scanning signal, a first capacitor connected between the first node and the maintaining node, a second capacitor connected between the first node and the second node, a third capacitor connected between the maintaining node and the second node. The driving transistor includes a first node that forms a gate node, a second node connected to the organic light-emitting diode and a third node connected to a driving voltage line. The first transistor is connected between a reset voltage line and the first node. The second transistor is connected between a maintaining node and the corresponding data line.

In an embodiment of the disclosure, when the organic light-emitting display device operates reset manipulation, the first transistor and the second transistor are turned on, the driving voltage line provides a low level driving voltage, the reset voltage line provides a low level reset voltage, the date lines provide a low level data voltage that is identical to the low level reset voltage. When the organic light-emitting display device operates collecting a threshold voltage manipulation, the first transistor is turned on, the second transistor is turned off. The driving voltage line provides a high level driving voltage. The reset voltage line provides the low level reset voltage. When the organic light-emitting display device operates data input manipulation, the first transistor is turned off, the second transistor is turned on. The driving voltage line provides the high level driving voltage. The data lines provide a high level data voltage. When the organic light-emitting display device operates light-emitting manipulation, the first transistor and the second transistor are turned off, the driving voltage line provides the high level driving voltage.

In the disclosure, the current flowing through the organic light-emitting diode and the threshold voltage of the driving transistor are unrelated, so as to eliminate the problem of poor performance in displaying images caused by threshold voltage drift of the driving transistor.

### BRIEF DESCRIPTION OF THE DRAWINGS

The above and other aspects, features and advantages of embodiments of the disclosure will be clearer by the following description with reference to accompanying drawings.

FIG. 1 is a circuit diagram of a basic driving circuit of a conventional AMOLED.

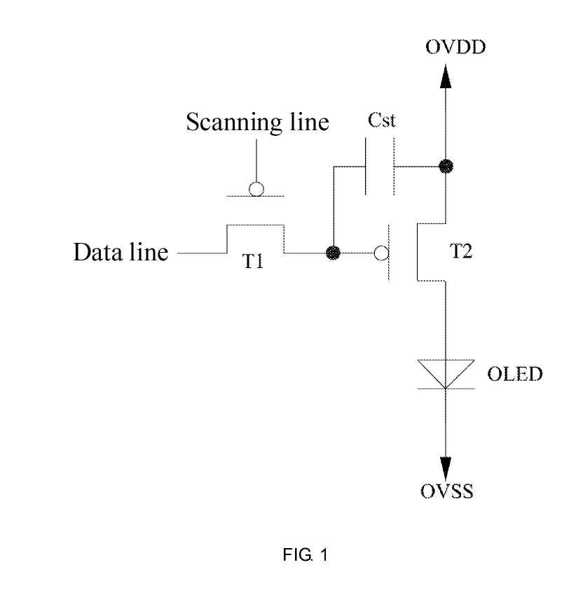

FIG. 2 is a structural view of an organic light-emitting display device according to an embodiment of the disclosure.

FIG. 3 is an equivalent circuit diagram of a pixel structure of an organic light-emitting display device according to an embodiment of the disclosure.

FIG. 4 is an operation sequence diagram of a pixel of a pixel structure of an organic light-emitting display device according to an embodiment of the disclosure.

### DETAILED DESCRIPTION OF PREFERRED EMBODIMENTS

Embodiments of the disclosure will be described in detail with reference to the accompanying drawings as follows. However, the disclosure can be implemented in various forms, and the disclosure should be explained beyond the concrete embodiments. On the contrary, the provided embodiments are for illustrating the principle and practical application of the disclosure, so that a person skilled in the art can understand various embodiments of the disclosure and modifications adapted to specific applications.

In the figures, thicknesses of layers and regions are exaggerated to clarify devices. An identical label represents the same device in the embodiments and figures.

Embodiments of the disclosure will be described in detail with reference to the accompanying drawings as follows. However, the disclosure can be implemented in various forms, and the disclosure should be explained beyond the concrete embodiments. On the contrary, the provided embodiments are for illustrating the principle and practical application of the disclosure, so that a person skilled in the art can understand various embodiments of the disclosure and modifications adapted to specific applications.

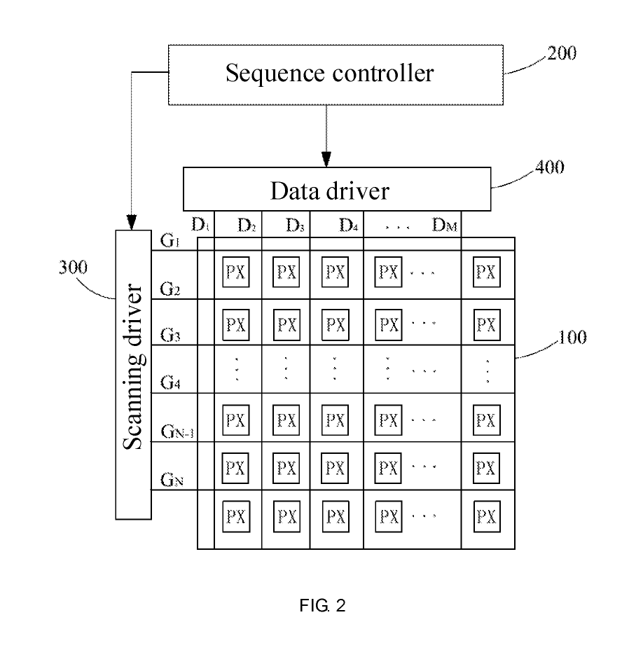

FIG. 2 is a structural view of an organic light-emitting display device according to an embodiment of the disclosure.

Referring to FIG. 2, the organic light-emitting display device according to the embodiment of the disclosure includes a display panel 100, a sequence controller 200, a scanning driver 300 and a data driver 400.

The display panel 100 includes a plurality of pixels PX arranged as an array, N scanning lines G₁ to G_{N}, M data lines D₁ to D_{M}. The scanning driver 300 is connected to the scanning lines G₁ to G_{N}, and driving the scanning lines G₁ to G_{N}. The data driver 400 is connected to the data lines D₁ to D_{M}, and driving the data lines D₁ to D_{M}.

The scanning driver 300 can provide one or more scanning signals to each of the pixels PX according to a plurality of pixel structures, which will be described below.

The sequence controller 200 controls operation sequence of the scanning driver 300 and the data driver 400, and outputs various control signals accordingly.

Each of the pixels PX includes an organic light-emitting diode (OLED) and a pixel driving circuit configured to drive the OLED. The pixel structures of the embodiment will be described in detail as follows.

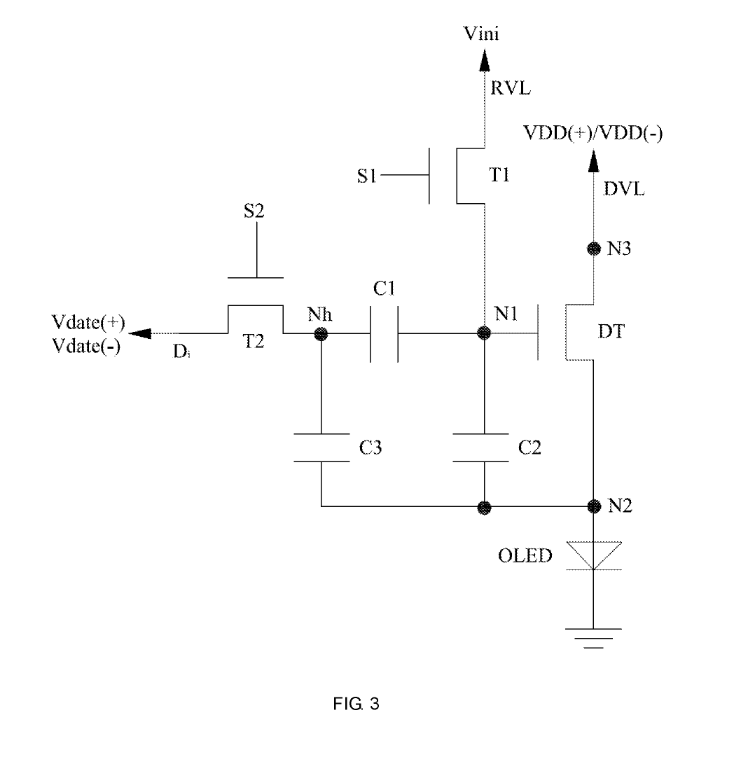

FIG. 3 is an equivalent circuit diagram of a pixel structure of an organic light-emitting display device according to an embodiment of the disclosure.

Referring to FIG. 3, each of the pixels PX according to the organic light-emitting display device of the embodiment of the disclosure has a 3T3C pixel structure, the 3T3C pixel structure includes the organic light-emitting diode OLED, a driving transistor DT, a first transistor T1, a second transistor T2, a first capacitor C1, a second capacitor C2 and a third capacitor C3.

The driving transistor DT is configured to drive the organic light-emitting diode OLED. The driving transistor DT includes a first node N1 that forms a gate node, a second node N2 connected to the organic light-emitting diode OLED and a third node connected to a driving voltage line DVL.

The first transistor T1 is controlled by a first scanning signal S1, the first transistor T1 is connected between a reset voltage line RVL and the first node N1.

The second transistor T2 is controlled by a second scanning signal S2, the second transistor T2 is connected between a maintaining node Nh and a data line Dᵢ (1«i«M).

The first capacitor C1 is connected between the first node N1 and the maintaining node Nh. The second capacitor C2 is connected between the first node N1 and the second node N2. The third capacitor C3 is connected between the maintaining node Nh and the second node N2.

Comparing capacitance of the first capacitor C1, the second capacitor C2 and the third capacitor C3, the capacitance of the third capacitor C3 is designed to be minimum.

The driving voltage line DVL provides a low level driving voltage VDD(−) or a high level driving voltage VDD(+). The reset voltage line RVL provides a low level reset voltage Vini. The data line Dᵢ provides a low level data voltage Vdate(−) (identical to the low level reset voltage Vini) or a high level data voltage Vdate(+).

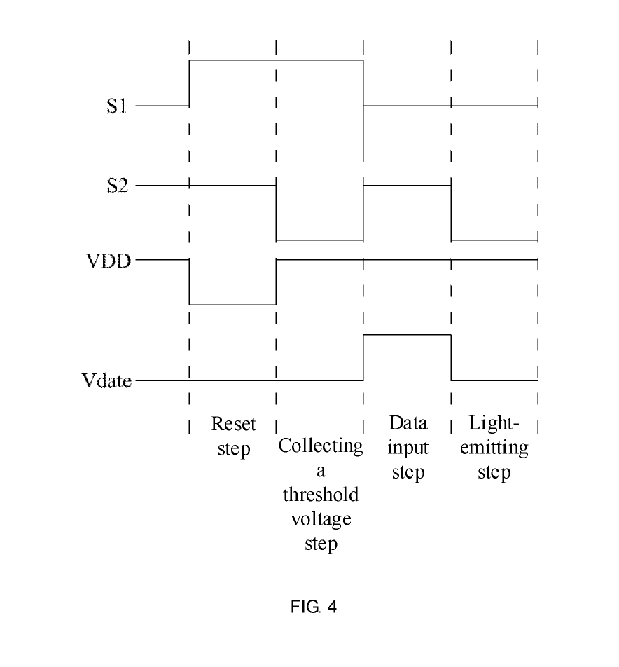

FIG. 4 is an operation sequence diagram of a pixel of a pixel structure of an organic light-emitting display device according to an embodiment of the disclosure.

Referring to FIG. 4, the pixels PX of the pixel structure of the organic light-emitting display device according to the embodiment of the disclosure operate a reset step (or an initialization step), a collecting a threshold voltage step, a data input step and a light-emitting step.

First, in the reset step, the first transistor T1 and the second transistor T2 are turned on, the driving voltage line DVL provides the low level driving voltage VDD(−), the reset voltage line RVL provides the low level reset voltage Vini, the date line Dᵢ provides the low level data voltage Vdate(−).

A voltage Vg of the first node N1, a voltage Vs of the second node N2 and a voltage Va of the maintaining node Nh are represented as Vg=Vini, Va=Vini, Vs=VDD(−), the first node N1 utilizes the low level reset voltage Vini to reset (or initialize), and the second node N2 utilizes the low level driving voltage VDD(−) to reset (or initialize).

Subsequently, in the collecting a threshold voltage step, the first transistor T1 is turned on, the second transistor T2 is turned off, the driving voltage line DVL provides the high level driving voltage VDD(+), the reset voltage line RVL provides the low level reset voltage Vini, the date line Dᵢ provides the low level data voltage Vdate(−).

The voltage Vg of the first node N1, the voltage Vs of the second node N2 and the voltage Va of the maintaining node Nh are represented as Vg=Vini, Va=Vini−Vth, Vs=Vini+[Cv1/(Cv2+Cv1)]*(Vini−Vth−VDD(−)), Vth represents the threshold voltage of the driving transistor DT, Cv1 represents the capacitance of the first capacitor C1, Cv2 represents the capacitance of the second capacitor C2.

Subsequently, in the data input step, the first transistor T1 is turned off, the second transistor T2 is turned on, the driving voltage line DVL provides the high level driving voltage VDD(+), the reset voltage line RVL provides the low level reset voltage Vini, the data line Dᵢ provides the high level data voltage Vdate(+).

The voltage Vg of the first node N1, the voltage Vs of the second node N2 and the voltage Va of the maintaining node Nh are represented as Va=Vdate(+), Vs=Vini−Vth+ΔV, Vg=Vini+B*ΔV+C*[Vdate(+)−Vini−B*(Vini−Vth−VDD(−))], B=Cv1/(Cv2+Cv1), C=Cv2/(Cv2+Cv1), ΔV represents a tiny voltage variation, which is a constant.

Finally, in the light-emitting step, the first transistor T1 and the second transistor T2 are both turned off, the driving voltage line DVL provides the high level driving voltage VDD(+), the reset voltage line RVL provides the low level reset voltage Vini, the data line Dᵢ provides the low level data voltage Vdate(−). In the light-emitting step, the driving transistor DT is turned on, the voltage Vg of the first node N1 and the voltage Vs of the second node N2 are both increased to be steady due to the coupling function of the capacitors with inflow of the current, but a voltage difference Vgs=Vg−Vs between the first node N1 and the second node N2 is constant.

Vgs=Vg−Vs=B*Vdate(+)+B*A*VDD(−)+A*B*Vth−ΔV(1−C)+Vth, A=Cv3/(Cv3+Cv1), Cv3 represents the capacitance of the third capacitor C3.

The current I flowing through the OLED is represented as I=K(Vgs−Vth)²=K[B*Vdate(+)+B*A*VDD(−)+B*A*Vth−ΔV(1−C)]², k represents an Eigen conductive factor of the driving transistor DT, which is determined by characteristics of the driving transistor DT.

In the formula of the current I flowing through the OLED, as the capacitance Cv3 of the third capacitor C3 is tiny compared with the capacitance Cv2 of the second capacitor C2 and the capacitance Cv1 of the first capacitor C1, A*B*Vth is almost zero, so that the current I flowing through the OLED and the threshold voltage Vth of the driving transistor DT are unrelated, which can eliminate the problem of poor performance in displaying AMOLED images caused by threshold voltage drift of the driving transistor DT.

Although the disclosure is illustrated with reference to specific embodiments, a person skilled in the art should understand that various modifications on forms and details can be achieved within the spirit and scope of the disclosure limited by the claims and the counterpart.

What is claimed is:

1. A pixel driving circuit, comprising:
an organic light-emitting diode;
a driving transistor driving the organic light-emitting diode, the driving transistor comprising a first node that forms a gate node, a second node connected to the organic light-emitting diode and a third node connected to a driving voltage line;
a first transistor controlled by a first scanning signal, the first transistor connected between a reset voltage line and the first node;
a second transistor controlled by a second scanning signal, the second transistor connected between a maintaining node and a data line;
a first capacitor connected between the first node and the maintaining node;
a second capacitor connected between the first node and the second node; and
a third capacitor connected between the maintaining node and the second node.

2. The pixel driving circuit according to claim 1, wherein capacitance of the third capacitor is less than capacitance of the first capacitor or capacitance of the second capacitor.

3. The pixel driving circuit according to claim 1, wherein the driving voltage line provides a low level driving voltage or a high level driving voltage, the reset voltage line provides a low level reset voltage, the data line provides a low level data voltage that is identical to the low level reset voltage or a high level data voltage;
the pixel driving circuit operating reset manipulation, collecting a threshold voltage manipulation, data input manipulation and light-emitting manipulation.

4. The pixel driving circuit according to claim 2, wherein the driving voltage line provides a low level driving voltage or a high level driving voltage, the reset voltage line provides a low level reset voltage, the data line provides a low level data voltage that is identical to the low level reset voltage or a high level data voltage;
the pixel driving circuit operating reset manipulation, collecting a threshold voltage manipulation, data input manipulation and light-emitting manipulation.

5. The pixel driving circuit according to claim 3, wherein when the pixel driving circuit operates the reset manipulation, the first transistor and the second transistor are turned on, the driving voltage line provides the low level driving voltage, the reset voltage line provides the low level reset voltage, the date line provides the low level data voltage.

6. The pixel driving circuit according to claim 4, wherein when the pixel driving circuit operates the reset manipulation, the first transistor and the second transistor are turned on, the driving voltage line provides the low level driving voltage, the reset voltage line provides the low level reset voltage, the date line provides the low level data voltage.

7. The pixel driving circuit according to claim 5, wherein when the pixel driving circuit operates the collecting a threshold voltage manipulation, the first transistor is turned on, the second transistor is turned off, the driving voltage line provides the high level driving voltage, the reset voltage line provides the low level reset voltage.

8. The pixel driving circuit according to claim 6, wherein when the pixel driving circuit operates the collecting a threshold voltage manipulation, the first transistor is turned on, the second transistor is turned off, the driving voltage line provides the high level driving voltage, the reset voltage line provides the low level reset voltage.

9. The pixel driving circuit according to claim 7, wherein when the pixel driving circuit operates the data input manipulation, the first transistor is turned off, the second transistor is turned on, the driving voltage line provides the high level driving voltage, the data line provides the high level data voltage.

10. The pixel driving circuit according to claim 8, wherein when the pixel driving circuit operates the data input manipulation, the first transistor is turned off, the second transistor is turned on, the driving voltage line provides the high level driving voltage, the data line provides the high level data voltage.

11. The pixel driving circuit according to claim 9, wherein when the pixel driving circuit operates the light-emitting manipulation, the first transistor and the second transistor are turned off, the driving voltage line provides the high level driving voltage.

12. The pixel driving circuit according to claim 10, wherein when the pixel driving circuit operates the light-emitting manipulation, the first transistor and the second transistor are turned off, the driving voltage line provides the high level driving voltage.

13. An organic light-emitting display device, comprising:
a display panel, disposed with data lines and scanning lines limiting a plurality of pixels;
a data driver driving the data lines;
a scanning driver driving the scanning lines;
a sequence controller controlling the data driver and the scanning driver;
the pixel comprising:
an organic light-emitting diode;
a driving transistor driving the organic light-emitting diode, the driving transistor comprising a first node that forms a gate node, a second node connected to the organic light-emitting diode and a third node connected to a driving voltage line;
a first transistor controlled by a first scanning signal, the first transistor connected between the a reset voltage line and the first node;
a second transistor controlled by a second scanning signal, the second transistor connected between a maintaining node and the corresponding data line;
a first capacitor connected between the first node and the maintaining node;
a second capacitor connected between the first node and the second node; and
a third capacitor connected between the maintaining node and the second node.

14. The organic light-emitting display device according to claim 13, wherein capacitance of the third capacitor is less than capacitance of the first capacitor or capacitance of the second capacitor.

15. The organic light-emitting display device according to claim 13, wherein when the organic light-emitting display device operates reset manipulation, the first transistor and the second transistor are turned on, the driving voltage line provides a low level driving voltage, the reset voltage line provides a low level reset voltage, the date lines provide a low level data voltage identical to the low level reset voltage;
when the organic light-emitting display device operates collecting a threshold voltage manipulation, the first transistor is turned on, the second transistor is turned off, the driving voltage line provides a high level driving voltage, the reset voltage line provides the low level reset voltage;
when the organic light-emitting display device operates data input manipulation, the first transistor is turned off, the second transistor is turned on, the driving voltage line provides the high level driving voltage, the data lines provide a high level data voltage;
when the organic light-emitting display device operates light-emitting manipulation, the first transistor and the second transistor are turned off, the driving voltage line provides the high level driving voltage.

16. The organic light-emitting display device according to claim 14, wherein when the organic light-emitting display device operates reset manipulation, the first transistor and the second transistor are turned on, the driving voltage line provides a low level driving voltage, the reset voltage line provides a low level reset voltage, the date lines provide a low level data voltage identical to the low level reset voltage;
when the organic light-emitting display device operates collecting a threshold voltage manipulation, the first transistor is turned on, the second transistor is turned off, the driving voltage line provides a high level driving voltage, the reset voltage line provides the low level reset voltage;
when the organic light-emitting display device operates data input manipulation, the first transistor is turned off, the second transistor is turned on, the driving voltage line provides the high level driving voltage, the data lines provide a high level data voltage;
when the organic light-emitting display device operates light-emitting manipulation, the first transistor and the second transistor are turned off, the driving voltage line provides the high level driving voltage.
